(19) United States
(12) Patent Application Publication
(10) Pub. No.: US 2024/0061087 A1
(43) Pub. Date: Feb. 22, 2024

(54) LIDAR SYSTEM WITH FLY'S EYE LENS ARRAYS

(71) Applicant: Ouster, Inc., San Francisco, CA (US)

(72) Inventors: Duncan Walker, Edinburgh (GB); Daniel Thomas Sing, San Francisco, CA (US)

(73) Assignee: Ouster, Inc., San Francisco, CA (US)

(21) Appl. No.: 18/447,471

(22) Filed: Aug. 10, 2023

Related U.S. Application Data
(60) Provisional application No. 63/373,033, filed on Aug. 19, 2022.

(51) Int. Cl. G01S 7/481; G01S 7/484; G01S 7/4863

(52) U.S. Cl. CPC G01S 7/4817; G01S 7/484; G01S 7/4863

(57) ABSTRACT

An optical system comprising: a sensor array having a field of view; an emitter array comprising a plurality of emitter units mounted on a surface of a common substrate and arranged in a two-dimensional array, wherein each emitter unit in the plurality of emitter units is spaced apart from its adjacent emitter units by a first pitch and emits pulses of light having a predetermined beam divergence; and a fly's eye element spaced apart from the emitter array and configured to spread light received from each emitter unit in the plurality of emitter units element across the entire field of view of the sensor array, the fly's eye element comprising a first and second arrays of lenslets spaced apart from each other, wherein individual lenslets in the first and second arrays of lenslets are spaced apart from each other in at least one dimension by a second pitch that is different than the first pitch, and wherein each individual lenslets in the first array of lenslets is aligned with a corresponding lenslet in the second arrays of lenslets.

### CROSS-REFERENCES TO RELATED APPLICATIONS

This application claims the benefit of U.S. Provisional Application No. 63/373,033, filed Aug. 19, 2022, which is incorporated by reference herein.

### FIELD

The present disclosure is directed to Light Detection and Ranging (LiDAR or lidar) systems.

### BACKGROUND

Various Light Detection and Ranging (lidar) systems measure distance to a target by illuminating the target with laser light and measuring the reflected light with a sensor. Various techniques, including direct or indirect time-of-flight measurements and frequency modulated continuous wave (FMCW) measurements, can then be used to make a digital 3D-representation of the target. Lidar systems can be used for a variety of applications where 3D depth images are useful including archaeology, geography, geology, forestry, mapping, construction, medical imaging and military applications, among others. Autonomous vehicles can also use lidar for obstacle detection and avoidance as well as vehicle navigation.

Some lidar systems include a mechanical, moving component that physically scans a transmitting and receiving element around a rotational angle of less than or equal to 360° to capture an image of a scene in a field. One example of such a system that can be used for obstacle detection and avoidance in vehicles is often referred to as a rotating or spinning lidar system. In a rotating lidar system, a lidar sensor is mounted, typically within a housing, to a column that rotates or spins a full 360 degrees. The lidar sensor includes coherent light emitters (e.g., pulsed lasers in the infrared or near-infrared spectrums) to illuminate a scene around the vehicle as the lidar sensor is continuously rotated through the scene. As the coherent light emitters spin around, they send pulses of electromagnetic radiation away from the lidar system in different directions in the scene. Part of the radiation, incident on surrounding objects in the scene, is reflected from these objects around the vehicle, and then these reflections are detected by the imaging system portion of the lidar sensor at different time intervals. The imaging system turns the detected light into electric signal.

In this way, information about objects surrounding the lidar system including their distances and shapes is gathered and processed. A digital signal processing unit of the lidar system can process the electric signals and reproduce information about objects in a depth image or a 3D point cloud that can be used as an aid in obstacle detection and avoidance as well as for vehicle navigation and other purposes. Additionally, image processing and image stitching modules can take the information and assemble a display of the objects around the vehicle.

Another type of mechanical lidar system steers a laser beam along a predetermined scan pattern using, for example, a MEMS mirror. The laser in such systems can be a single laser that is directed by the mirror into the field according to two-dimensional scan pattern or can be an array of lasers that is directed into the field according to either a one- or two-dimensional scan pattern.

Solid-state lidar systems also exist that do not include any moving mechanical parts. Instead of rotating through a scene, some solid-state lidar systems illuminate an entire portion of a scene they intend to capture with light and sense the reflected light. In some solid-state systems, the transmitter includes one or more emitters that can emit light simultaneously to illuminate the entire scene, with each detector observing a discrete portion of that scene. With no moving mechanical parts, solid-state lidar systems can be highly reliable and rugged and can also be less designed to be less obtrusive than spinning lidar systems.

Some manufacturers are developing solid-state lidar systems that employ vertical cavity surface emitting lasers (VCSELs) as the illumination source. VCSELs are generally a lower power illumination source than other types of lasers, such as edge emitting lasers (EELs). VCSELs offer advantages, however, that are not obtainable with EELs. In general, VCSELs are smaller, more durable, faster and more cost efficient than EELs. Also, because of the vertically emitting nature of a VCSEL, they can be packed together such that many individual VCSELs fit as part of a dense array onto a single chip.

In order to sufficiently illuminate a desired field of view at ranges suitable for some applications, such as autonomous driving, a relative large number of VCSELs need to be fired simultaneously, which creates various design challenges with respect to power management, uniformity of illumination in the far field, and other issues. Additionally, if solid-state lidar is going to be widely adopted to enable autonomous driving in automobiles and similar applications, the price point of solid-state lidar devices needs to be competitive with other technologies.

### SUMMARY

Some embodiments of the disclosure pertain to stationary, solid-state lidar systems in which there is no spinning column, no MEMs scanning mirror and no other moving parts. Embodiments can illuminate the far field in a highly uniform manner to image a scene at a high resolution and low power consumption with a high degree of reliability. Additionally, embodiments can have a small form factor that enables the Lidar systems to be located inconspicuously on a vehicle and used for autonomous driving and other applications.

In some embodiments an optical system is provided that includes: a sensor array having a field of view; an emitter array comprising a plurality of emitter units mounted on a surface of a common substrate and arranged in a two-dimensional array, wherein each emitter unit in the plurality of emitter units is spaced apart from its adjacent emitter units by a first pitch and emits pulses of light having a predetermined beam divergence; and a fly's eye element spaced apart from the emitter array and configured to spread light received from each emitter unit in the plurality of emitter units across the entire field of view of the sensor array, the fly's eye element comprising a first and second arrays of lenslets spaced apart from each other, wherein individual lenslets in the first and second arrays of lenslets are spaced apart from each other in at least one dimension by a second pitch that is different than the first pitch, and wherein each individual lenslets in the first array of lenslets is aligned with a corresponding lenslet in the second arrays of lenslets.

In additional embodiments the optical system includes: a sensor array having a field of view, the sensor array comprising a plurality of single photon avalanche diodes (SPADs); an emitter array comprising a plurality of emitter units mounted on a surface of a common substrate and arranged in a two-dimensional array, wherein each emitter unit in the plurality of emitter units is spaced apart from its adjacent emitter units by a first pitch and emits pulses of light having a predetermined beam divergence; a fly's eye element spaced apart from the emitter array, positioned to receive light from the emitter array and configured to generate a flood illumination profile that macroscopically matches the field of view of the sensor array, the fly's eye element comprising a first and second arrays of lenslets spaced apart from each other, wherein individual lenslets in the first and second arrays of lenslets are spaced apart from each other in at least one dimension by a second pitch that is different than the first pitch, and wherein each individual lenslets in the first array of lenslets is aligned with a corresponding lenslet in the second arrays of lenslets; and a timing generator and driver circuitry operatively coupled to control the emitter array to emit radiation pulses at a desired time and frequency. In some implementations, the optical system can be part of a solid-state lidar system that does not include any moving parts.

In still other embodiments, a solid-state lidar system is provided that includes: a sensor array having a field of view; an emitter array comprising a plurality of emitter units mounted on a surface of a common substrate and arranged in a two-dimensional array, wherein each emitter unit in the plurality of emitter units is spaced apart from its adjacent emitter units by a first pitch and emits light having a predetermined beam divergence; and a fly's eye element spaced apart from the emitter array, positioned to receive light from the emitter array and configured to generate a flood illumination profile that macroscopically matches the field of view of the sensor array, the fly's eye element comprising a first and second arrays of lenslets spaced apart from each other, wherein individual lenslets in the first and second arrays of lenslets are spaced apart from each other in at least one dimension by a second pitch that is different than the first pitch, and wherein each individual lenslets in the first array of lenslets is aligned with a corresponding lenslet in the second arrays of lenslets.

In various implementations, the optical system and/or the solid state lidar system can include one or more of the following features. Cones of light generated by each emitter unit in the emitter array can have a lower divergence angle than a beam of light generated by the fly's eye element in the X axis. Individual lenslets in the first and second arrays can be spaced apart from each other along the X axis by the second pitch and can be spaced apart from each other along the Y axis by a third pitch that is different than the first pitch and different than the second pitch. The system can further include an array of collimating lenslets disposed between the emitter array and the fly's eye element. Each lenslet in the array of collimating lenslets is aligned with a corresponding emitter unit in the emitter array and spaced apart from adjacent lenslets in the plurality of collimating lenslets by the first pitch. The fly's eye element can be a single, monolithic optical component with the first array of lenslets formed on a first side of the optical component and the second array of lenslets formed on a second side of the optical component opposite the first side. The second pitch can be smaller than the first pitch. The system can further include a timing generator and driver circuitry operatively coupled to control the emitter array to emit radiation pulses at a desired time and frequency. The emitter array can include a plurality of separate VCSEL chips mounted on a common substrate. The driver circuitry can be mounted on the common substrate in close proximity to the VCSEL chips. And, the fly's eye element can be mounted to the common substrate. The first and second arrays of lenslets in the fly's eye element can be spaced apart from each other by the focal length (f) of the lenslets. The sensor array can include a plurality of single photon avalanche diodes (SPADs). The fly's eye element can be engineered to create a flood illumination profile that macroscopically matches a field of view of the sensor array. The sensor array can include a plurality of sensors arranged in a two-dimensional array. Each sensor in the sensor array can comprise an array of single photon avalanche diodes (SPADs). Each sensor in the sensor array can be coupled to memory circuitry configured to accumulate histogram data for the sensor.

A better understanding of the nature and advantages of embodiments of the disclosed embodiments can be gained with reference to the following detailed description and the accompanying drawings. It is to be understood, however, that each of the figures is provided for the purpose of illustration only and is not intended as a definition of the limits of the scope of the invention. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 is a simplified block diagram of a Light Detection and Ranging (lidar) system according to some embodiments;

FIG. 2 is a simplified block diagram of components of a time-of-flight measurement system or circuit according to some embodiments;

FIG. 3 is a simplified cross-sectional illustration of an optical system in accordance with some embodiments;

FIG. 4A is a simplified diagram depicting light output from a single emitter unit into a fly's eye element according to some embodiments;

FIG. 4B is a simplified top plan view diagram of an emitter array that is part of the optical system depicted in FIG. 4A according to some embodiments;

FIG. 5A is a simplified diagram depicting light intensity levels received at a fly's eye element according to some embodiments;

FIG. 5B is a simplified diagram depicting the light intensity levels of the target beam output from a fly's eye element in accordance with some embodiments when receiving beams of light as depicted in FIG. 5A;

FIG. 6 is a simplified cross-sectional illustration of an optical system in accordance with some embodiments;

FIG. 7 is a simplified cross-sectional illustration of an optical system in accordance with some embodiments; and

FIG. 8 is a simplified illustration of an automobile in which four solid-state lidar sensors are included at different locations along the automobile according to some embodiments.

### DETAILED DESCRIPTION

Embodiments of the present disclosure are described herein with reference to solid-state lidar applications and systems. A solid-state lidar system can include an array of emitter elements and an array of sensors. As described herein, one or more emitter elements can define an emitter unit, and one or more photodetectors can define a sensor. Some embodiments of a solid-state lidar system described herein can acquire images by emitting light from an array, or a subset of the array, of emitter units for short durations (pulses) over the entire field of view of the system. In contrast, a scanning lidar system generates image frames by raster scanning light emission (continuously) over a field of view or scene, for example, using a point scan or line scan to emit the necessary illumination power per point and sequentially scan to reconstruct the full field of view.

### Example Lidar System

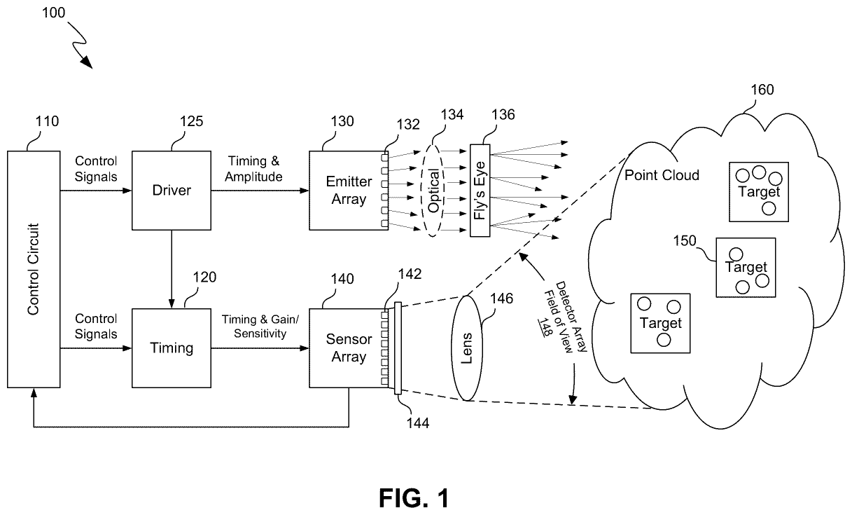

FIG. 1 illustrates an example light-based 3D sensor system 100, such as a Light Detection and Ranging (lidar) system, in accordance with some embodiments of the present disclosure. Lidar system 100 can include a control circuit 110, a timing circuit 120, driver circuitry 125, an emitter array 130 and a sensor array 140. Emitter array 130 can include a plurality of emitter units 132 arranged in an array (e.g., a one- or two-dimensional array) and sensor array 140 can include a plurality of sensors 142 arranged in a two-dimensional array. The sensors 142 can be depth sensors, such as time-of-flight (ToF) sensors. In some embodiments each sensor 142 can be, for example, an array of single-photon detectors, such as single photon avalanche diodes (SPADs). In some embodiments, each sensor 142 can be coupled to an in-pixel memory block (not shown) that accumulates histogram data for that sensor 142, and the combination of a sensor and in-pixel memory circuitry is sometimes referred to as a “pixel” 142. Each emitter unit 132 of the emitter array 130 can include one or more emitter elements and emit a radiation pulse (e.g., a light pulse) or continuous wave signal at a time and frequency controlled by a timing generator or driver circuitry 125. In some embodiments, the emitter units 132 can be pulsed light sources, such as LEDs or lasers, such as vertical cavity surface emitting lasers (VCSELs) that emit a cone of light (e.g., infrared light) having a predetermined beam divergence.

Emitter array 130 can project pulses of radiation into a field ahead of the lidar system 100. Some of the emitted radiation can then be reflected back from objects in the field, such as targets 150. The radiation that is reflected back can then be sensed or detected by the sensors 142 within the sensor array 140. Control circuit 110 can implement a pixel processor that measures and/or calculates the distance to targets 150. In some embodiments control circuit 110 can measure and/or calculate the time of flight of the radiation pulses over the journey from emitter array 130 to target 150 and back to the detectors 142 within the sensor array 140 using direct or indirect time of flight (ToF) measurement techniques. In other embodiments control circuit 110 can measure and/or calculate distances to target 150 by detecting the frequency of a continuous beam of light emitted from emitter array 130 and reflected back from target 150 using frequency modulation continuous wave (FMCW).

As described in more detail below, in some embodiments, emitter array 130 can include an array (e.g., a one or two-dimensional array) of emitter units 132 where each emitter unit is a unique semiconductor chip having a plurality of individual VCSELs (sometimes referred to herein as emitter elements) formed on the chip. A fly's eye element 136 can be disposed in the optical path of the emitter units such that light projected by the emitter units passes through the fly's eye element 136 prior to exiting lidar system 100. In some embodiments, an additional optional optical element 134 (e.g., an array of micro-lenses that collimate or reduce the angle of divergence of light received at the optical element 134 and pass the altered light to fly's eye element 136) can be included in the optical path of system 100 between emitter array 130 and fly's eye element 136. For convenience, optical element 134 is sometimes referred to herein as “collimating lens array 134” or “collimating lenslet array 134”).

Fly's eye element 136 can be designed to spread light received at the fly's eye element over an area in the far field that can be referred to as the field of view of the emitter array (or the field of illumination of the emitter array). In general, emitter array 130, collimating lens array 134 (if included) and fly's eye element 136 cooperate to spread light from emitter array 130 across the entire field of view of the emitter array. Further details on example implementations of the emitter array 130, collimating lens array 134 and fly's eye element 136 are discussed below.

The driver circuitry 125 can include one or more driver circuits each of which controls one or more emitter units. The driver circuits can be operated responsive to timing control signals with reference to a master clock and/or power control signals that control the peak power and/or the repetition rate of the light output by the emitter units 132. In some embodiments, each of the emitter units 132 in the emitter array 130 is connected to and controlled by a separate circuit in driver circuitry 125. In other embodiments, a group of emitter units 132 in the emitter array 130 (e.g., emitter units 132 in spatial proximity to each other or in a common column of the emitter array), can be connected to a same circuit within driver circuitry 125. The driver circuitry 125 can include one or more driver transistors configured to control the modulation frequency, timing and amplitude of the optical emission signals that are output from the emitter units 132.

In some embodiments, a single event of emitting light from the multiple emitter units 132 can illuminate an entire image frame (or field of view); this is sometimes referred to as a “flash” lidar system. Other embodiments can include non-flash or scanning lidar systems, in which different emitter units 132 emit light pulses at different times, e.g., into different portions of the field of view. The maximum optical power output of the emitter units 132 can be selected to generate a signal-to-noise ratio of the echo signal from the farthest, least reflective target at the brightest background illumination conditions that can be detected in accordance with embodiments described herein. In some embodiments, an optional filter (not shown), such as a bandpass filter, can be included in the optical path of the emitter units 132 to control the emitted wavelengths of light.

Light output from the emitter units 132 can impinge on and be reflected back to lidar system 100 by one or more targets 150 in the field. The reflected light can be detected as an optical signal (also referred to herein as a return signal, echo signal, or echo) by one or more of the sensors 142 (e.g., after being collected by receiver optics 146), converted into an electrical signal representation (sometimes referred to herein as a detection signal), and processed (e.g., based on time of flight techniques or FMCW techniques) to define a 3-D point cloud representation 160 of a field of view 148 of the sensor array 140. Operations of lidar systems in accordance with embodiments of the present disclosure as described herein can be performed by one or more processors or controllers, such as control circuit 110.

Sensor array 140 includes an array of sensors 142 (sometimes referred to as pixels). In some embodiments, each sensor or pixel can include one or more photodetectors, e.g., SPADs. And in some particular embodiments, the sensor array is a very large array made up of hundreds of thousands or even millions of densely packed SPADs. Receiver optics 146 and receiver electronics (including timing circuit 120) can be coupled to the sensor array 140 to power, enable, and disable all or parts of the sensor array 140 and to provide timing signals thereto. In some embodiments, the sensors can be activated or deactivated with at least nanosecond precision (e.g., time periods, bins, or intervals of 1 ns, 2 ns etc.), and in various embodiments, can be individually addressable, addressable by group, and/or globally addressable. The receiver optics 146 can include a bulk optic lens that is configured to collect light from the largest field of view that can be imaged by the lidar system 100, which in some embodiments is determined by the aspect ratio of the two-dimensional sensor array combined with the focal length of the receiver optics 146.

In some embodiments, the receiver optics 146 can further include lenses (not shown) to improve the collection efficiency of the detecting pixels, and/or an anti-reflective coating (also not shown) to reduce or prevent detection of stray light. In some embodiments, a spectral filter 144 can be positioned in front of the sensor array 140 to pass or allow passage of ‘signal’ light (i.e., light of wavelengths corresponding to those of the optical signals output from the emitter units) but substantially reject or prevent passage of non-signal light (i.e., light of wavelengths different than the optical signals output from the emitter units). The spectral filter can be, for example, a bandpass filter that passes a very narrow band of wavelengths (e.g., electromagnetic radiation) centered at the operational wavelength of emitter array.

The sensors 142 of sensor array 140 are connected to the timing circuit 120. The timing circuit 120 can be phase-locked to the driver circuitry 125 of emitter array 130. The sensitivity of each of the sensors 142 or of groups of sensors can be controlled. For example, when the detector elements include reverse-biased photodiodes, avalanche photodiodes (APD), PIN diodes, and/or geiger-mode avalanche diodes (i.e., SPADs), the reverse bias can be adjusted. In some embodiments, a higher overbias provides higher sensitivity.

In some embodiments, control circuit 110, which can be, for example, a microcontroller or microprocessor, provides different emitter control signals to the driver circuitry 125 of different emitter units 132 and/or provides different signals (e.g., strobe signals) to the timing circuitry 120 of different sensors 142 to enable/disable the different sensors 142 so as to detect the echo signal from the target 150. The control circuit 110 can also control memory storage operations for storing data indicated by the detection signals in a non-transitory memory or memory array that is included therein or is distinct therefrom.

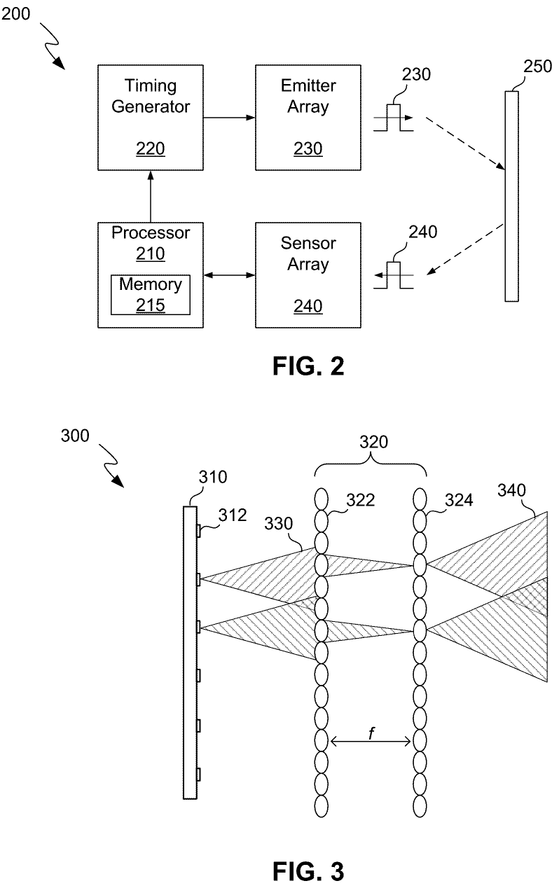

FIG. 2 further illustrates components of a ToF measurement system or circuit 200 in a lidar application in accordance with some embodiments described herein. The circuit 200 can include a processor circuit 210 (such as a digital signal processor (DSP)), a timing generator 220 that controls timing of the illumination source (illustrated by way of example with reference to a laser emitter array 230), and an array of sensors (illustrated by way of example with reference to a sensor array 240). The processor circuit 210 can also include a sequencer circuit (not shown in FIG. 2) that is configured to coordinate operation of emitter units within the illumination source (emitter array 230) and sensors within the sensor array 240.

The processor circuit 210 and the timing generator 220 can implement some of the operations of the control circuit 110 and the driver circuitry 125 of FIG. 1. Similarly, emitter array 230 and sensor array 240 can be representative of emitter array 130 and sensor array 140 in FIG. 1. The laser emitter array 230 can emit laser pulses 235 at times controlled by the timing generator 220. Light 245 from the laser pulses 235 can be reflected back from a target (illustrated by way of example as object 250), and can be sensed by sensor array 240. The processor circuit 210 implements a pixel processor that can measure or calculate the time of flight of each laser pulse 235 and its reflected signal 245 over the journey from emitter array 230 to object 250 and back to the sensor array 240.

The processor circuit 210 can provide analog and/or digital implementations of logic circuits that provide the necessary timing signals (such as quenching and gating or strobe signals) to control operation of the single-photon detectors of the array 240 and process the detection signals output therefrom. For example, individual single-photon detectors of sensor array 240 can be operated such that they generate detection signals in response to incident photons only during the gating intervals or strobe windows that are defined by the strobe signals. Photons that are incident outside the strobe windows have no effect on the outputs of the single photon detectors. More generally, the processor circuit 210 can include one or more circuits that are configured to generate detector control signals that control the timing and/or durations of activation of the sensor pixels 142 (or particular single-photon detectors therein), and/or to generate respective emitter control signals that control the output of optical signals from the emitter units 132.

Detection events can be identified by the processor circuit 210 based on one or more photon counts indicated by the detection signals output from the sensor array 240, which can be stored in a non-transitory memory 215. In some embodiments, the processor circuit 210 can include a correlation circuit or correlator that identifies detection events based on photon counts (referred to herein as correlated photon counts) from two or more detectors within a predefined window of time relative to one another, referred to herein as a correlation window or correlation time, where the detection signals indicate arrival times of incident photons within the correlation window. Since photons corresponding to the optical signals output from the emitter array 230 (also referred to as signal photons) can arrive relatively close in time as compared to photons corresponding to ambient light (also referred to as background photons), the correlator is configured to distinguish signal photons based on respective times of arrival within the correlation time relative to one another. Such correlators and strobe windows are described, for example, in U.S. Patent Publication No. 2019/0250257 entitled “Methods and Systems for High-Resolution Long Range Flash Lidar,” which is incorporated by reference herein in its entirety for all purposes.

The processor circuit 210 can be small enough to allow for three-dimensionally stacked implementations, e.g., with the sensor array 240 “stacked” on top of processor circuit 210 (and other related circuits) that is sized to fit within an area or footprint of the sensor array 240. For example, some embodiments can implement the sensor array 240 on a first substrate, and transistor arrays of the circuits 210 on a second substrate, with the first and second substrates/wafers bonded in a stacked arrangement, as described for example in U.S. patent application Ser. No. 16/668,271 entitled “High Quantum Efficiency Geiger-Mode Avalanche Diodes Including High Sensitivity Photon Mixing Structures and Arrays Thereof,” filed Oct. 30, 2019, the disclosure of which is incorporated by reference herein in its entirety for all purposes.

The pixel processor implemented by the processor circuit 210 can be configured to calculate an estimate of the average ToF aggregated over hundreds or thousands of laser pulses 235 and photon returns in reflected light 245. The processor circuit 210 can be configured to count incident photons in the reflected light 245 to identify detection events (e.g., based on one or more SPADs within the sensor array 240 that have been “triggered”) over a laser cycle (or portion thereof).

The timings and durations of the detection windows can be controlled by a strobe signal (Strobe #i or Strobe<i>). Many repetitions of Strobe #i can be aggregated (e.g., in the pixel) to define a sub-frame for Strobe #i, with subframes i=1 to n defining an image frame. Each sub-frame for Strobe #i can correspond to a respective distance sub-range of the overall imaging distance range. In a single-strobe system, a sub-frame for Strobe #i can correspond to the overall imaging distance range and is the same as an image frame since there is a single strobe. The time between emitter unit pulses (which defines a laser cycle, or more generally emitter pulse frequency) can be selected to define or can otherwise correspond to the desired overall imaging distance range for the ToF measurement system 200. Accordingly, some embodiments described herein can utilize range strobing to activate and deactivate sensors for durations or “detection windows” of time over the laser cycle, at variable delays with respect to the firing of the laser, thus capturing reflected correlated signal photons corresponding to specific distance sub-ranges at each window/frame, e.g., to limit the number of ambient photons acquired in each laser cycle.

The strobing can turn off and on individual photodetectors or groups of photodetectors (e.g., for a pixel), e.g., to save energy during time intervals outside the detection window. For instance, a SPAD or other photodetector can be turned off during idle time, such as after an integration burst of time bins and before a next laser cycle. As another example, SPADs can also be turned off while all or part of a histogram is being read out from non-transitory memory 215. Yet another example is when a counter for a particular time bin reaches the maximum value (also referred to as “bin saturation”) for the allocated bits in the histogram stored in non-transitory memory 215. A control circuit can provide a strobe signal to activate a first subset of the sensors while leaving a second subset of the sensors inactive. In addition or alternatively, circuitry associated with a sensor can also be turned off and on as specified times.

The sensors be arranged in a variety of ways for detecting reflected pulses. For example, the sensors can be arranged in an array, and each sensor can include an array of photodetectors (e.g., SPADs). A signal from a photodetector indicates when a photon was detected and potentially how many photons were detected. For example, a SPAD can be a semiconductor photodiode operated with a reverse bias voltage that generates an electric field of a sufficient magnitude that a single charge carrier introduced into the depletion layer of the device can cause a self-sustaining avalanche via impact ionization. The initiating charge carrier can be photo-electrically generated by a single incident photon striking the high field region. The avalanche is quenched by a quench circuit, either actively (e.g., by reducing the bias voltage) or passively (e.g., by using the voltage drop across a serially connected resistor), to allow the device to be “reset” to detect other photons. This single-photon detection mode of operation is often referred to as “Geiger Mode,” and an avalanche can produce a current pulse that results in a photon being counted. Other photodetectors can produce an analog signal (in real time) proportional to the number of photons detected. The signals from individual photodetectors can be combined to provide a signal from the sensor, which can be a digital signal. This signal can be used to generate histograms.

### Emitter Module

Referring back to FIG. 1, in some embodiments the circuitry and emitter units that combine to generate and project pulses of light into the field can be fabricated together as part of a single component referred to herein as an emitter module. For example, in some embodiments emitter array 130 can be formed from a plurality of separate VCSEL chips that are mounted on a common substrate. Driver circuitry 125 can be formed on the common substrate in close proximity to the VCSEL chips to improve electrical characteristics of the system and optical element 134 (if included) and fly's eye element 136 can be mounted to the common substrate as part of the emitter module.

In a solid-state system lidar system in which there are no moving parts (e.g., no motor that spins the lidar system and no MEMS mirror or similar device that scans a relatively small laser array across the field of view of the system), emitter array 130 needs to project a sufficient amount of optical power to illuminate the entire field of view the lidar system is designed for at the distance the lidar system is designed for. While in some embodiments emitter array 130 can be formed from a single semiconductor chip densely packed with thousands of VCSELs that illuminate the desired field of view, managing thermal issues associated with such a chip and incorporating the necessary electronics to efficiently drive the emitter units can be challenging all of which can increase the price of developing a solid-state lidar system around a single large array VC SEL chip.

Instead of using a single large array VCSEL chip as emitter array 130, some embodiments take advantage of the relatively low price of commercially available high powered VC SEL chips and mount multiple such VC SEL chips on a common circuit board. To illustrate, consider an embodiment where approximately 10,000 Watts of emitter power is required to fully and adequately illuminate a desired field of view at the intended range limitation of the lidar system. If emitter array 130 includes multiple VC SEL chips that output 300 Watts peak power per chip in such an embodiment, at least 33 separate VCSEL chips are required to illuminate the field of view. Further details of embodiments with an emitter array that includes multiple separate VCSEL chips are described below.

As described above, in some embodiments, emitter array 130 and fly's eye element 136 (and optical element 134, if included) can cooperate to spread light from the emitter array 130 uniformly across the entire field of illumination of the emitter array. Each emitter unit 132 emits a cone of light having a specific angle of divergence. For instance, as non-limiting examples, in various embodiments the emitter units can emit a cone of light having an angle of divergence between 15 and 25 degrees FWHM (full width half maximum). In some specific implementations, each emitter unit can emit a cone of light having an angle of divergence of about 17 degrees. Fly's eye element 136 can be engineered to spread the received light to desired angles in the far field while generating a far field light pattern that is substantially uniform as discussed below. Thus, fly's eye element 136 enables the far field cone angle to be independent from the cone angle of individual emitter units.

In some embodiments, fly's eye element 136 is engineered to create a flood illumination profile that macroscopically matches the field of view of the sensor array 140. For example, fly's eye element 136 can be engineered to spread the received light over a field of illumination of the emitter array (sometimes referred to herein as the field of view of the emitter array) such that the entire field of view of the sensor array 140 is illuminated substantially equally (given constraints of the optical system). Precisely matching the emitter array and sensor array fields of view, minimizes the waste of laser light thus ensuring that most, if not all, of the light projected into the field from the emitter array 130 contributes to the range and accuracy of lidar system 100. Matching the emitter array and sensor array fields of view also prevents or minimizes the possibility of light hitting objects (e.g., a highly reflective stop sign) outside the sensor array field of view that might otherwise reflect light back to the sensor array polluting or corrupting data collected by the sensor array.

1. Fly's Eye Element

Reference is now made to FIG. 3, which is a simplified schematic illustration of an optical system 300 that includes an emitter array 310 and a fly's eye optical element 320. Emitter array 310 can be representative of emitter array 130 and 230 discussed above, while fly's eye element 320 can be representative of fly's eye element 136 discussed above. As shown, emitter array 310 can include multiple emitter units 312 arranged in an array. While only a single dimension (e.g., the Y axis) is illustrated in FIG. 3, in typical embodiments emitter units 312 are arranged in a two dimensional array. Fly's eye element 320 includes two identical arrays 322, 324 of lenslets spaced apart from emitter array 310 and spaced apart from each other by the focal length (f) of the lenslets in the two lens arrays 322, 324.

Each emitter unit 312 can output a cone of light 330 (e.g., pulses of infrared light) having a predetermined angle of divergence. The cones of light 330 are received by fly's eye element 320 and shaped into a target beam 340 that is output from optical system 300. In some embodiments, first lens array 322 receives the cones of light 330 and focuses the received cones onto second lens array 324 (for ease of illustration, only the light focused by two individual lenslets in array 322 is depicted in FIG. 3). The second lens array 324 images the shape of the lenslets into the far field as target beam 340. In this manner, fly's eye element 320 can generate a highly homogenous (uniform from edge to edge) target beam that has a far field cone angle independent from the cone angle of each individual emitter unit 312. The pitch and focal length of the fly's eye element 320 can be chosen to give target beam 340 desired beam requirements.

Importantly, in some embodiments, the two lens arrays 322, 324 each have the same pitch which is different from the pitch of emitter array 310. As an example, in one embodiment, emitter units 312 are spaced apart from each other along the X and Y axes at a pitch of 3.6 mm while individual lenses in each of the lens arrays 322, 324 are spaced apart from each other along the X axis at a pitch of 1.2 mm and spaced apart from each other along the Y axis at a pitch of 2.3 mm. Having different pitches between emitter array 310 and each of the fly's eyes lens arrays 322, 324 results in the emitter array having a different number of emitter units 312 than there are lenses in each of the lens arrays 322, 324. For example, in one embodiment, each of the fly's eye lens arrays 322, 324 have more than 100 lenslets while emitter array 310 includes an array of 6×8 emitter units 312 for a total of forty-eight (48) emitter units. Having different numbers of optical elements and different pitches between the emitter units and lenslets in the fly's eye arrays means that each individual emitter unit 312 is not aligned with a particular, corresponding lenslet in the fly's eye lens arrays 322, 324. Such a design eliminates the necessity of optics that collimate the beams output from emitter units 312, which requires that such optics are precisely aligned in a one-to-one correspondence with emitter units of the emitter array 310. The design also eliminates any need to tightly align or precisely register fly's eye element 320 to emitter array 310 in the manner that some optical systems require arrays of micro-optic lenses to be precisely aligned with an emitter array so that each emitter element projects its light into one specific corresponding lenslet in the micro-optic array.

Fly'e eye element 320 can be designed with efficiency, uniformity and eye safety in mind. In some embodiments, efficiency is maximized by employing emitter units 312 that generate cones of light 330 that have a lower divergence angle than that of the target beam 340 generated by fly's eye element 320 in both the X and Y axes. Selecting the emitter units 312 and fly's eye element 320 that have such characteristics ensures that all the light generated by the emitter array 310 is projected through fly's eye element 320 into the far field. If, on the other hand, emitter units 312 are employed in optical system 300 that generate cones of light 330 having a higher divergence angle than that of the target beam 340 in one or both of the X and Y axes, some light projected by emitter array 310 will be lost in the far field. In some embodiments, the divergence angle of light cones 330 can be slightly larger than that of target beam 340 in one of the X or Y axes in order to provide a certain amount of tolerance during the manufacturing process of optical system 300.

Uniformity can be designed for, in part, by including at least a certain number of lenslets in each of the fly's eye arrays 322, 324. Since each subsection of the fly's eye element 320 projects to the entire far field image, some embodiments include at least 100 lenslets to generate a far field image having uniformity of some applications. There is some small amount of light lost at the interfaces between each adjacent lenslet. Thus, some embodiments select the number of lenslets in each of the fly's eyes arrays 322, 324 by balancing the increased uniformity achieved with more lenslets with the level of optical loss that can be experienced if too many lenslets are included in each of the arrays 322, 324.

Eye safety can be designed for based on the power and wavelength of light output by the emitter units 312. The inventors have found that reducing the size of lenslets in fly's eye element 320 and setting the distance between emitter array 310 and fly's eye element 320 to at least a minimum distance (e.g., about 20 mm in some embodiments) can improve eye safety and uniformity in some embodiments.

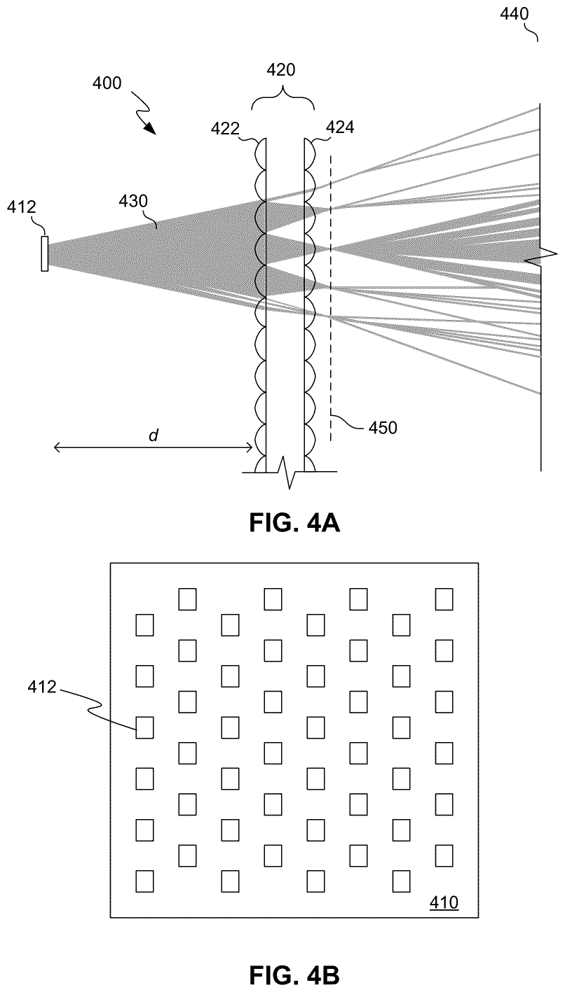

As one particular example, reference is made to FIGS. 4A and 4B in which FIG. 4A is a simplified diagram depicting of a portion of an optical system 400 designed in accordance with embodiments disclosed herein and FIG. 4B is a simplified top plan view of an emitter array 410 that is part of optical system 400. Optical system 400, which can be an implementation of optical system 300, includes an emitter array 410 with forty-eight (48) separate emitter units 412 that project infrared light (e.g., 940 nm wavelength) into a fly's eye element 420 positioned a distance, d, that in the particular implementation depicted is twenty (20) mm away from the emitter units. For convenience and ease of illustration, only a single emitter unit 412 is shown in FIG. 4A.

As shown, the fly's eye element 420 includes two lenslet arrays 422, 424 registered and aligned with each other. Each of the lenslet arrays 422, 424 includes four hundred and five (405) lenslets arranged in a 27×15 array. The focal length of the lenslets is 4.44 mm and the lenslets are spaced apart along the X axis at a 1.2 mm pitch and along the Y axis at a 2.3 mm pitch. The emitter units 412 are spaced apart from each other by a 3.6 mm pitch and each emitter unit is a single VCSEL chip that includes a hexagonal arrangement of 472 VCELs with a 0.047 mm spacing. The light cone 430 generated by each emitter unit has a divergence angle of 17 degrees and the fly's eye element reshapes the light cones it receives into a target beam 440 (of which only a portion generated by the single emitter 412 is shown in FIG. 4) that has a far field angle of 30 degrees in the X axis and 15 degrees in the Y axis.

Each light cone 430 generated by an emitter unit 412 is spread over multiple individual lenslets in lenslet array 422 and then focused by the lenslet array 422 such that the emitter unit is imaged at image plane 450 spaced slightly after lenslet array 424. In the implementation depicted in FIGS. 4A and 4B, imaging the emitter units 412 onto an image plane slightly past lenslet array 424 drops the light from each emitter unit slightly to ensure that target beam 440 is eye safe at both the individual emitter unit level as well as for the entire ensemble of emitter units.

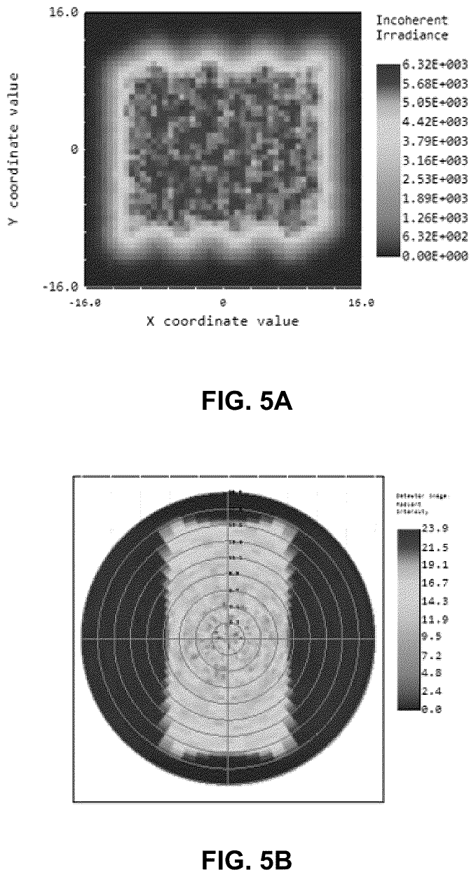

FIG. 5A is a diagram depicting light intensity levels received at the fly's eye element when each of the forty-eight (48) emitter units 412 in the emitter array of optical system 400 is flashed simultaneously at an average power of 62 mW and FIG. 5B is a diagram depicting the light intensity levels of the target beam output from the fly's eye element. As evident from FIG. 5A, the spot distribution of the emitter array has some overlap in the central portion of light pattern. The overlap helps with both uniformity and allows for reduced power to be used in the secondary sources. As evident from FIG. 4B, the fly's eye element generates a highly uniform target beam in the far field. The target beam is oversized in the X axis and slightly undersized in the Y axis.

2. Monolithic Fly's Eye Element

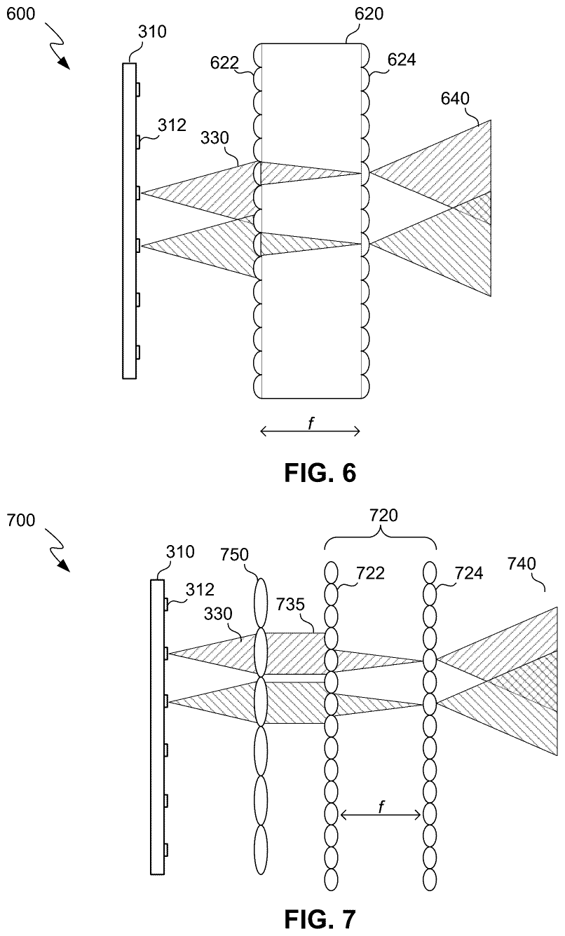

In some embodiments, the fly's eye element can be fabricated as a single optical element that includes a first array of lenslets on one side of the optical element and a second array of lenslets on an opposite side. To illustrate, reference is made to FIG. 6, which is a simplified cross-sectional diagram of an optical system 600 in accordance with some embodiments. Optical system 600 includes an emitter array 310 and a fly's eye optical element 620. Emitter array 310 can be similar to or identical to the emitter array 310 discussed above with respect to FIG. 3 and thus can be representative of emitter array 130 or 230 while fly's eye element 620 can be representative of fly's eye element 136 discussed with respect to FIG. 1.

Fly's eye element 620 can accept the same light cones as input as fly's eye element 320 and generate substantially the same target beam. Instead of having two separate lenslet arrays 322, 324 spaced apart from each other, however, fly's eye element 620 can be a single optical component that has lenslet arrays 622, 624 positioned on opposite faces of a monolithic block of optically transparent material. The lenslets in array 622 can focus light cones received from the emitter units 312 onto the lenslets 624 which, in turn, can generate a target beam 640 in the far field having the desired characteristics. In some embodiments, lenslet array 622 can be optically equivalent to lenslet array 322 and lenslet array 624 can be optically equivalent to lenslet array 324. Similar to other figures in the present application, for ease of illustration, FIG. 6 only illustrate the portion of light cones 330 focused onto lenslet array 624 by two individual lenslets in lenslet array 622.

The two lenslet arrays 622, 624 can be spaced apart from each other by the focal length of the lenses in the arrays. Instead of having empty space between the two arrays, however, fly's eye element 620 can include the same optical material 626 in between the lenslet arrays 622, 624 as the lenses are made out of. In various embodiments, optical material 626 can be glass or a plastic that is optically transparent to the wavelength of light emitted from the emitter array 310.

Fabricating the fly's eye element as a single, monolithic optical component can provide both efficiency and manufacturing benefits. For example, the lenslets 622 can be registered and aligned to lenslets 624 during the fabrication process. Thus, no additional alignment step is necessary. Additionally, the single optical component 620 can be less expensive than two separate optical components 322, 324.

3. Collimating Lenslets

To improve efficiency in embodiments where the far field angle is smaller than the angle of divergence of individual emitters, some embodiments disclosed herein can include an array of collimating lenses. FIG. 7 is a simplified cross-sectional diagram of an optical system 700 in accordance with some embodiments. Optical system 700 includes an emitter array 310 and a fly's eye optical element 720. Emitter array 310 can be similar to or identical to the emitter array 310 discussed above with respect to FIG. 3 and thus can be representative of emitter array 130 or 230 while fly's eye element 720 can be representative of fly's eye element 136 discussed with respect to FIG. 1. Optical system 700 can also include an optical element 750 that can receive the cones of light 330 from emitter array 310 and collimate or reduce the divergence angle of the received light in at least one dimension (i.e., a dimension that has a field of view angle smaller than that of the individual emitter units) before passing the light (beams 735) on to fly's eye element 720. In some embodiments, optical element 750 can be an array of collimating lenslets and can be representative of optical element 134 discussed above with respect to FIG. 1

As one non-limiting example, in one particular embodiment each emitter unit can be a VCSEL chip having between 300-600 individual densely packed VCSELs formed on the chip that together emit a light cone away from the VCSEL chip having an angle of divergence of approximately 17 degrees in both the X and Y axes. If a lidar system (e.g., lidar system 100) is designed to have a field of view of 15 degrees along the X axis and 30 degrees along the Y axis, optical element 750 can reduce the divergence angle of the emitted light cone in the X axis from each emitter unit to approximately 15 degrees to improve efficiency of the lidar system.

### Sensor Array

The sensor array employed in some embodiments (e.g., sensor array 140) can include a large, densely packed array of SPADs. Various ones of the SPADs can be coupled in an arrangement that provides a large array of sensors where each sensor includes multiple SPADs. The field of view and resolution of the sensor array can depend on several interrelated factors, such as, but not limited to, focal length of the lens paired with sensor array, size of the sensor array, pitch of the sensors and the pitch of the SPADs within each individual sensor. In general, the field of view of the sensor array will be matched to the field of illumination of the emitter array. Larger sensor arrays can result in larger field of views where the size of the sensor pitch is constant. Additionally, smaller sensor pitches can result in higher resolution images in instances where the size of the sensor array is constant, but can result in smaller fields of view of each sensor.

### Multiple Lidar Units

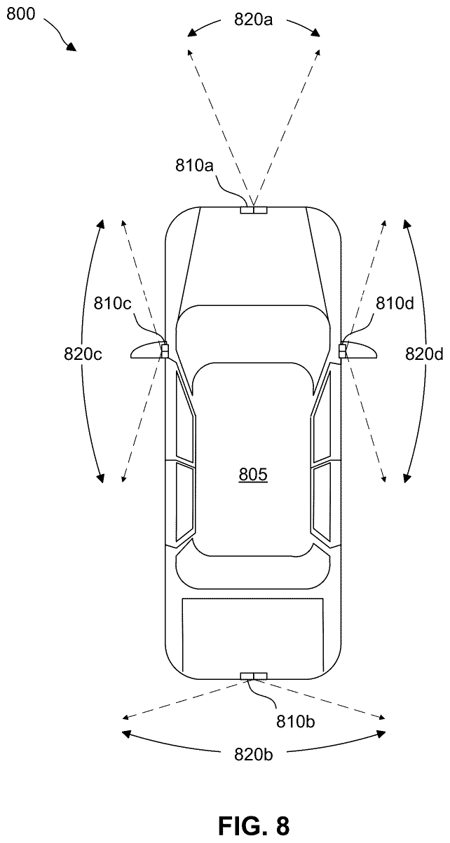

Depending on their intended purpose or application, lidar sensors can be designed to meet different field of view and different range requirements. For example, an automobile (e.g., a passenger car) outfitted with lidar for autonomous driving might be outfitted with multiple separate lidar sensors including a forward-facing long range lidar sensor, a rear-facing short range lidar sensor and one or more short range lidar sensors along each side of the car. FIG. 8 is a simplified illustration of an automobile 800 in which four solid-state lidar sensors 810a-d are included at different locations along the automobile. The number of lidar sensors, the placement of the lidar sensors, and the fields of view of each individual lidar sensors can be chosen to obtain a majority of, if not the entirety of, a 360 degree field of view of the environment surrounding the vehicle some portions of which can be optimized for different ranges. For example, lidar sensor 810a, which is shown in FIG. 8 as being positioned along the front bumper of automobile 800, can be a long range (200 meter), narrow field of view unit, while lidar sensors 810b, positioned along the rear bumper, and lidar systems 810c, 810d, positioned at the side mirrors, are short range (50 meter), wide field of view systems.

Despite being designed for different ranges and different fields of view, each of the lidar sensors 810a-810d can be a lidar system according to embodiments disclosed herein. Indeed, in some embodiments, the only difference between each of the lidar sensors 810a-810d is the properties of the fly's eye element (e.g., fly's eye element 136). For example, in long range, narrow field of view lidar sensor 810a, the fly's eye element 136 can be engineered to concentrate the light emitted by the emitter array of the lidar system over a relatively narrow range enabling the long distance operation of the sensor. In the short range, wide field of view lidar sensor 810b, the fly's eye element 136 can be engineered to spread the light emitted by the emitter array over a wide angle (e.g., 180 degrees). In each of the lidar sensors 810a and 810b, the same emitter array, the same sensor array and the same controller, etc. can be used thus simplifying the manufacture of multiple different lidar sensors tailored for different purposes.

### ADDITIONAL EMBODIMENTS

In the above detailed description, numerous specific details are set forth to provide a thorough understanding of embodiments of the present disclosure. However, it will be understood by those skilled in the art that the present disclosure may be practiced without these specific details. For example, while various embodiments set forth above described emitting pulses of laser light, embodiments described herein can be used with lidar devices that employ continuous wave techniques to measure distances, such as frequency modulated continuous wave (FMCW) techniques. As another example, while various embodiments of optical systems are described above with respect to a solid-state lidar system, the optical systems described can be incorporated into rotating lidar systems in other embodiments. It is to be understood that those embodiments are for illustrative purposes only and embodiments are not limited to any particular number of columns or rows of emitter units.

Additionally, in some instances, well-known methods, procedures, components, and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

Although the present disclosure has been described with respect to specific embodiments, it will be appreciated that the present disclosure is intended to cover all modifications and equivalents within the scope of the following claims.

What is claimed is:

1. An optical system comprising:
a sensor array having a field of view;
an emitter array comprising a plurality of emitter units mounted on a surface of a common substrate and arranged in a two-dimensional array, wherein each emitter unit in the plurality of emitter units is spaced apart from its adjacent emitter units by a first pitch and emits pulses of light having a predetermined beam divergence; and
a fly's eye element spaced apart from the emitter array and configured to spread light received from each emitter unit in the plurality of emitter units across an entire field of view of the sensor array, the fly's eye element comprising a first and second arrays of lenslets spaced apart from each other, wherein individual lenslets in the first and second arrays of lenslets are spaced apart from each other in at least one dimension by a second pitch that is different than the first pitch, and wherein each individual lenslets in the first array of lenslets is aligned with a corresponding lenslet in the second arrays of lenslets.

2. The optical system set forth in claim 1 wherein cones of light generated by each emitter unit in the emitter array have a lower divergence angle than a beam of light generated by the fly's eye element in an X-axis.

3. The optical system set forth in claim 1 wherein the individual lenslets in the first and second arrays are spaced apart from each other along the X-axis by the second pitch and are spaced apart from each other along a Y-axis by a third pitch that is different than the first pitch and different than the second pitch.

4. The optical system set forth in claim 1 further comprising an array of collimating lenslets disposed between the emitter array and the fly's eye element, wherein each lenslet in the array of collimating lenslets is aligned with a corresponding emitter unit in the emitter array and spaced apart from adjacent lenslets in the array of collimating lenslets by the first pitch.

5. The optical system set forth in claim 1 wherein the fly's eye element is a single, monolithic optical component with the first array of lenslets formed on a first side of the optical component and the second array of lenslets formed on a second side of the optical component opposite the first side.

6. The optical system set forth in claim 1 wherein the second pitch is smaller than the first pitch.

7. The optical system set forth in claim 1 wherein the optical system is part of a solid-state lidar system that does not include any moving parts.

8. The optical system set forth in claim 7 further comprising a timing generator and driver circuitry operatively coupled to control the emitter array to emit radiation pulses at a desired time and frequency.

9. The optical system set forth in claim 8 wherein the emitter array comprises a plurality of separate VCSEL chips mounted on a common substrate, the driver circuitry is mounted on the common substrate in close proximity to the VCSEL chips, and the fly's eye element is mounted to the common substrate.

10. The optical system set forth in claim 1 wherein the first and second arrays of lenslets in the fly's eye element are spaced apart from each other by a focal length (f) of the lenslets.

11. The optical system set forth in claim 1 wherein the sensor array comprises a plurality of single photon avalanche diodes (SPADs).

12. The optical system set forth in claim 11 wherein the fly's eye element is engineered to create a flood illumination profile that macroscopically matches a field of view of the sensor array.

13. The optical system set forth in claim 1 wherein the sensor array comprises a plurality of sensors arranged in a two-dimensional array.

14. The optical system set forth in claim 13 wherein each sensor comprises an array of single photon avalanche diodes (SPADs).

15. The optical system set forth in claim 14 wherein each sensor in the plurality of sensors is coupled to memory circuitry configured to accumulate histogram data for the sensor.

16. An optical system for measuring distances, the optical system comprising:
a sensor array having a field of view, the sensor array comprising a plurality of single photon avalanche diodes (SPADs);
an emitter array comprising a plurality of emitter units mounted on a surface of a common substrate and arranged in a two-dimensional array, wherein each emitter unit in the plurality of emitter units is spaced apart from its adjacent emitter units by a first pitch and emits pulses of light having a predetermined beam divergence;
a fly's eye element spaced apart from the emitter array, positioned to receive light from the emitter array and configured to generate a flood illumination profile that macroscopically matches the field of view of the sensor array, the fly's eye element comprising a first and second arrays of lenslets spaced apart from each other, wherein individual lenslets in the first and second arrays of lenslets are spaced apart from each other in at least one dimension by a second pitch that is different than the first pitch, and wherein each individual lenslets in the first array of lenslets is aligned with a corresponding lenslet in the second arrays of lenslets; and
a timing generator and driver circuitry operatively coupled to control the emitter array to emit radiation pulses at a desired time and frequency.

17. The optical system set forth in claim 16 further comprising an array of collimating lenslets disposed between the emitter array and the fly's eye element, wherein each lenslet in the array of collimating lenslets is aligned with a corresponding emitter unit in the emitter array and spaced apart from adjacent lenslets in the plurality of collimating lenslets by the first pitch.

18. The optical system set forth in claim 16 wherein the emitter array comprises a plurality of separate VCSEL chips mounted on a common substrate, the driver circuitry is mounted on the common substrate in close proximity to the VC SEL chips, and the fly's eye element is mounted to the common substrate.

19. A solid-state lidar system comprising:
a sensor array having a field of view;
an emitter array comprising a plurality of emitter units mounted on a surface of a common substrate and arranged in a two-dimensional array, wherein each emitter unit in the plurality of emitter units is spaced apart from its adjacent emitter units by a first pitch and emits light having a predetermined beam divergence; and
a fly's eye element spaced apart from the emitter array, positioned to receive light from the emitter array and configured to generate a flood illumination profile that macroscopically matches the field of view of the sensor array, the fly's eye element comprising a first and second arrays of lenslets spaced apart from each other, wherein individual lenslets in the first and second arrays of lenslets are spaced apart from each other in at least one dimension by a second pitch that is different than the first pitch, and wherein each individual lenslets in the first array of lenslets is aligned with a corresponding lenslet in the second arrays of lenslets.

20. The solid state lidar system set forth in claim 19 wherein each sensor in the sensor array comprises an array of single photon avalanche diodes (SPADs) and is coupled to memory circuitry configured to accumulate histogram data for the sensor.
